(19) United States
(12) Patent Application Publication
(10) Pub. No.: US 2017/0181582 A1
(43) Pub. Date: Jun. 29, 2017

(54) MOBILE FOOD CART

(71) Applicant: QING ZHANG, Los Angeles, CA (US)

(72) Inventor: QING ZHANG, Los Angeles, CA (US)

(21) Appl. No.: 15/391,021

(22) Filed: Dec. 27, 2016

Related U.S. Application Data
(60) Provisional application No. 62/271,269, filed on Dec. 27, 2015.

(51) Int. Cl. A47J 47/14; A47J 27/00

(52) U.S. Cl. CPC A47J 47/14; A47J 27/002

(57) ABSTRACT

A mobile food service cart may include a main body, a food making assemblies, a plurality of storage compartments, a protective glass, and a wheel assembly. In one embodiment, the food making assembly may include a plurality of cooking units, food processing arms, heating units, and heating source. In a further embodiment, the cooking unit may be a metal cooking pan that can be used to make food such as pizza, pancakes, etc. The food processing arm is configured to flatten the food material disposed on the cooking unit, and the heating unit is used to heat the food material on the cooking unit.

### CROSS-REFERENCE TO RELATED APPLICATIONS

This application claims priority under 35 U.S.C. §119 (e) to U.S. Provisional Patent Application Ser. No. 62/271,269, filed on Dec. 27, 2015, the entire contents of which are hereby incorporated by reference.

### FIELD OF THE INVENTION

The present invention relates to a food cart, and more particularly to a food cart that can be used to a mobile indoor-outdoor food cart to server as portable service counters and to provide the food to customers in an efficient way.

### BACKGROUND OF THE INVENTION

At public events and gatherings of many types, food carts are common for snack or light lunch food items served to patrons or guests of the event or gathering. Typically, these food items would include hot sandwiches such as hot dogs or hamburgers, other freshly cooked items such as popcorn, or chilled or frozen items such as ice cream, beverages, and the like. In sports events, food courts, etc., the food carts are usually large mobile vans or portable kitchens because a permanently installed facility is probably not necessary. At both of the above classes of events, it is possible to provide relatively fully equipped kitchens and food processing facilities and to equip these facilities with running water and other sanitary features which are desirable in serving food to the public.

However, typical food carts usually need a few working staffs to greet customers, cook the food and check out the customers. Therefore, there remains a need for a new and improved mobile food cart to handle the food more efficiently to save the labor costs.

### SUMMARY OF THE INVENTION

It is an object of the present invention to provide a mobile food service stand to more efficiently handle the food to save the labor costs.

It is another object of the present invention to provide a mobile food service stand to make the food while maintaining sanitary conditions.

It is a further object of the present invention to provide a mobile food service stand to efficiently make food such as pizza and pancakes.

In one aspect, a mobile food service cart may include a main body, a food making assemblies, a plurality of storage compartments, a protective glass, and a wheel assembly. In one embodiment, the food making assembly may include a plurality of cooking units, food processing arms, heating units, and heating source. In a further embodiment, the cooking unit may be a metal cooking pan that can be used to make food such as pizza, pancakes, etc. The food processing arm is configured to flatten the food material disposed on the cooking unit, and the heating unit is used to heat the food material on the cooking unit.

More specifically, when in use, the food material can be disposed on the cooking unit, and an operator of the food cart can activate the food processing arm that would gradually move down to the cooking unit to flatten the food material thereon. Meanwhile, the heating unit is configured to provide heat to the cooking unit until the desired food is done.

The present invention is advantageous because the food making process is semi-automatic, namely, the operator only needs to put the food material on the cooking unit and activate the food processing arm, and the desired food can be made without any further labor involved, so the labor costs can be significantly reduced. Furthermore, since the food making process is semi-automatic, the quality of the food can be easily controlled.

### BRIEF DESCRIPTION OF THE DRAWINGS

FIG. 1 illustrates a schematic view of the mobile food cart in the present invention.

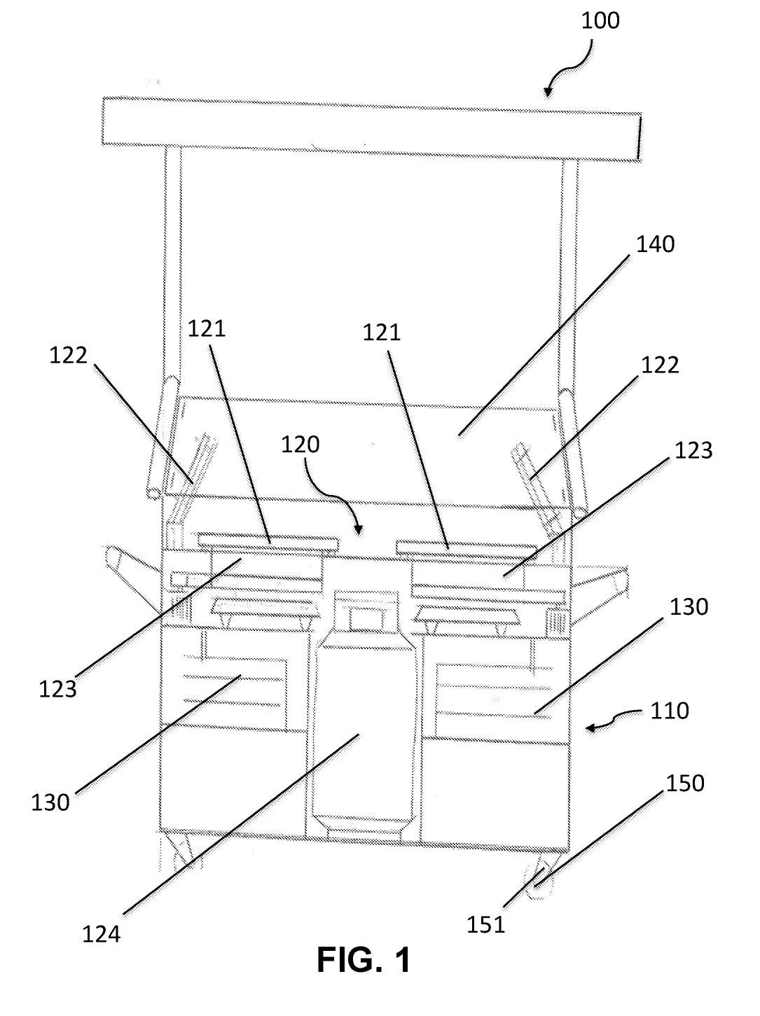

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In one aspect, a mobile food service cart 100 may include a main body 110, a food making assemblies 120, a plurality of storage compartments 130 to store food materials, ingredients, tools, etc., a protective glass 140 on top of the food making assemblies 120, and a wheel assembly 150. In one embodiment, the food making assembly 120 may include a plurality of cooking units 121, food processing arms 122, heating units 123, and heating source 124. In a further embodiment, the cooking unit 121 may be a metal cooking pan that can be used to make food such as pizza, pancakes, etc. The food processing arm 122 is configured to flatten the food material disposed on the cooking unit 121, and the heating unit 123 is used to heat the food material on the cooking unit 121. The wheel assembly 150 may include a brake unit 151, so the food cart can be fixed when it is operated.

More specifically, when in use, the food material can be disposed on the cooking unit 121, and an operator of the food cart 100 can activate the food processing arm 122 that would gradually move down to the cooking unit 121 to flatten the food material thereon. Meanwhile, the heating unit 123 is configured to provide heat to the cooking unit 121 until the desired food is done.

The present invention is advantageous because the food making process is semi-automatic, namely, the operator only needs to put the food material on the cooking unit 121 and activate the food processing arm 122, and the desired food can be made without any further labor involved, so the labor costs can be significantly reduced. Furthermore, since the food making process is semi-automatic, the quality of the food can be easily controlled.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A mobile food cart comprising:
a main body;
a food making assemblies having a plurality of cooking units, food processing arms, heating units, and heating source; and
a wheel assembly,
wherein a food material being cooked is disposed on one of the cooking units, the food processing arm is configured to flatten the food material, and the heating unit is used to heat the food material on the cooking unit until the food material is done.

2. The mobile food cart of claim 1, wherein the cooking unit is a metal cooking pan.

3. The mobile food cart of claim 1, further comprising a protective glass on top of the food making assemblies.

4. The mobile food cart of claim 1, further comprising a plurality of storage compartments.

5. The mobile food cart of claim 2, further comprising a protective glass on top of the food making assemblies.

6. The mobile food cart of claim 5, further comprising a plurality of storage compartments.

7. The mobile food cart of claim 1, wherein the wheel assembly include a brake unit, so the food cart is fixed when operated.

8. The mobile food cart of claim 6, wherein the wheel assembly include a brake unit, so the food cart is fixed when operated.
